(19) United States
(12) Patent Application Publication
(10) Pub. No.: US 2021/0390434 A1
(43) Pub. Date: Dec. 16, 2021

(54) MACHINE LEARNING ERROR REPORTING

(71) Applicant: QUALCOMM Incorporated, San Diego, CA (US)

(72) Inventors: Tianyang BAI, Somerville, NJ (US); Hua WANG, Basking Ridge, NJ (US); Jung Ho RYU, Fort Lee, NJ (US); Junyi LI, Fairless Hills, PA (US)

(21) Appl. No.: 17/344,013

(22) Filed: Jun. 10, 2021

Related U.S. Application Data
(60) Provisional application No. 63/038,505, filed on Jun. 12, 2020.

(51) Int. Cl. G06N 5/04; H04W 24/08; H04W 24/10; G06N 20/00

(52) U.S. Cl. CPC G06N 5/045; G06N 20/00; H04W 24/10; H04W 24/08

(57) ABSTRACT

Various aspects of the present disclosure generally relate to wireless communication. In some aspects, a user equipment may apply a machine learning-based model to one or more functions for wireless communication, determine an error event associated with the machine learning-based model based at least in part on applying the machine learning-based model, and transmit, to a base station, an error report based at least in part on determining the error event associated with the machine learning-based model. Numerous other aspects are provided.

### CROSS-REFERENCE TO RELATED APPLICATION

This patent application claims priority to U.S. Provisional Patent Application No. 63/038,505, filed on Jun. 12, 2020, entitled “MACHINE LEARNING ERROR REPORTING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for machine learning error reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a user equipment (UE), may include applying a machine learning-based model to one or more functions for wireless communication; determining an error event associated with the machine learning-based model based at least in part on applying the machine learning-based model; and transmitting, to a base station, an error report based at least in part on determining the error event associated with the machine learning-based model.

In some aspects, a method of wireless communication, performed by a base station, may include receiving, from a UE, an error report indicating an error event associated with a machine learning-based model; determining one or more updated parameters of the machine learning-based model based at least in part on receiving the error report; and transmitting a configuration for the machine learning-based model, wherein the configuration indicates the one or more updated parameters of the machine learning-based model.

In some aspects, a UE for wireless communication may include a memory and one or more processors coupled to the memory. The memory and the one or more processors may be configured to apply a machine learning-based model to one or more functions for wireless communication; determine an error event associated with the machine learning-based model based at least in part on applying the machine learning-based model; and transmit, to a base station, an error report based at least in part on determining the error event associated with the machine learning-based model.

In some aspects, a base station for wireless communication may include a memory and one or more processors coupled to the memory. The memory and the one or more processors may be configured to receive, from a UE, an error report indicating an error event associated with a machine learning-based model; determine one or more updated parameters of the machine learning-based model based at least in part on receiving the error report; and transmit a configuration for the machine learning-based model, wherein the configuration indicates the one or more updated parameters of the machine learning-based model.

In some aspects, a non-transitory computer-readable medium may store one or more instructions for wireless communication. The one or more instructions, when executed by one or more processors of a UE, may cause the one or more processors to apply a machine learning-based model to one or more functions for wireless communication; determine an error event associated with the machine learning-based model based at least in part on applying the machine learning-based model; and transmit, to a base station, an error report based at least in part on determining the error event associated with the machine learning-based model.

In some aspects, a non-transitory computer-readable medium may store one or more instructions for wireless communication. The one or more instructions, when executed by one or more processors of a base station, may cause the one or more processors to receive, from a UE, an error report indicating an error event associated with a machine learning-based model; determine one or more updated parameters of the machine learning-based model based at least in part on receiving the error report; and transmit a configuration for the machine learning-based model, wherein the configuration indicates the one or more updated parameters of the machine learning-based model.

In some aspects, an apparatus for wireless communication may include means for applying a machine learning-based model to one or more functions for wireless communication; means for determining an error event associated with the machine learning-based model based at least in part on applying the machine learning-based model; and means for transmitting, to a base station, an error report based at least in part on determining the error event associated with the machine learning-based model.

In some aspects, an apparatus for wireless communication may include means for receiving, from a UE, an error report indicating an error event associated with a machine learning-based model; means for determining one or more updated parameters of the machine learning-based model based at least in part on receiving the error report; and means for transmitting a configuration for the machine learning-based model, wherein the configuration indicates the one or more updated parameters of the machine learning-based model.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example associated with machine learning error reporting, in accordance with the present disclosure.

FIGS. 4-5 are diagrams illustrating example processes associated with machine learning error reporting, in accordance with the present disclosure.

FIGS. 6-7 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

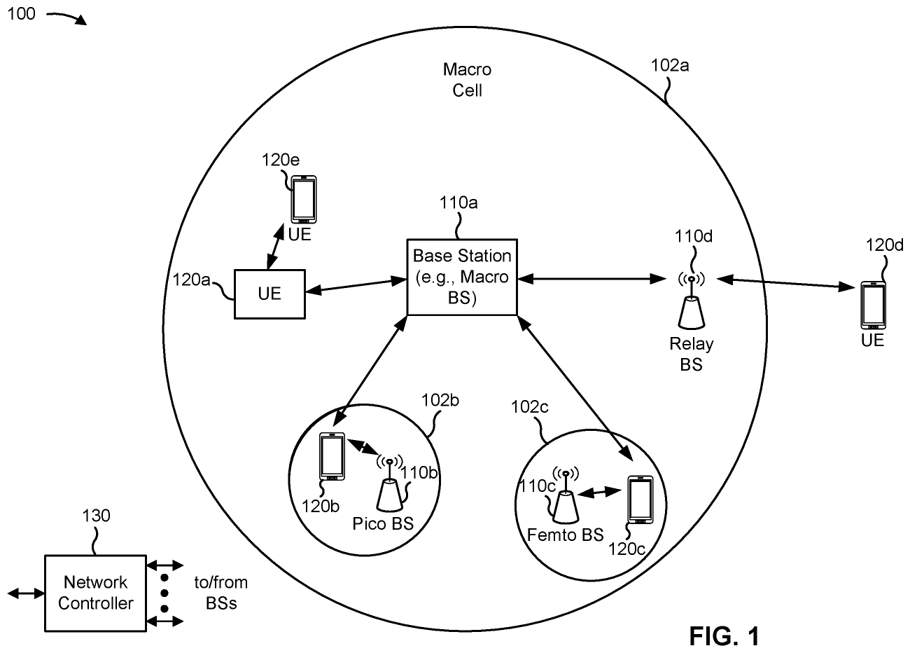

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

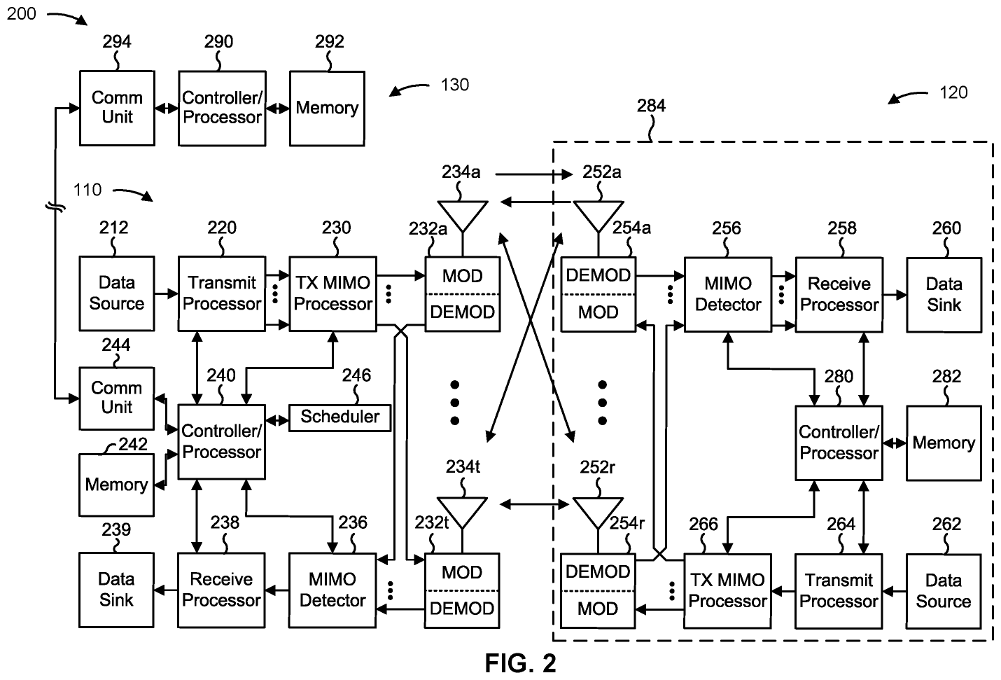

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

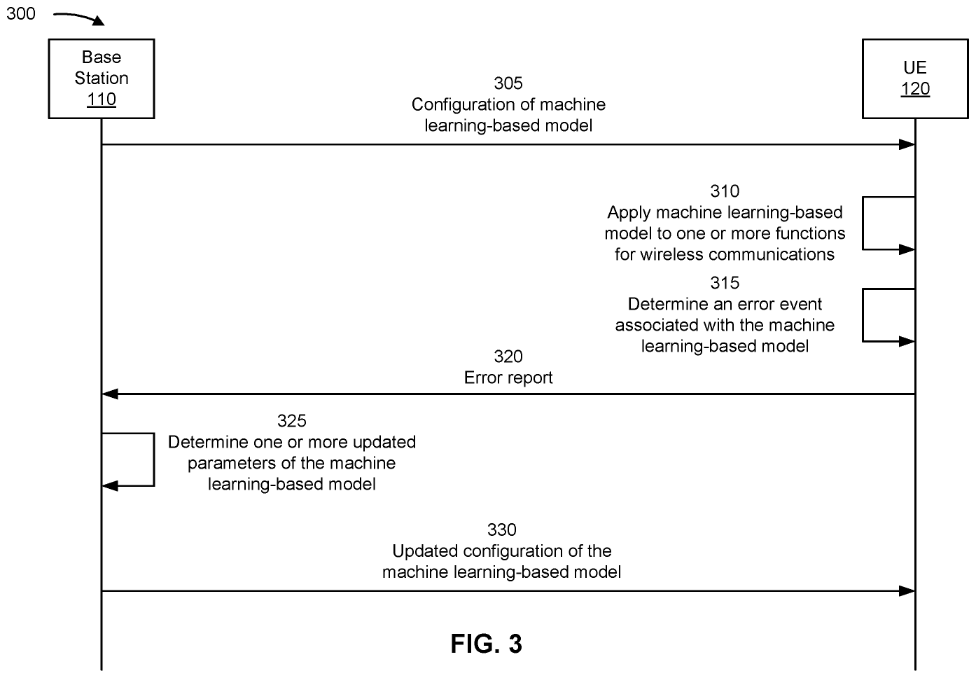

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 3-7).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 3-7).

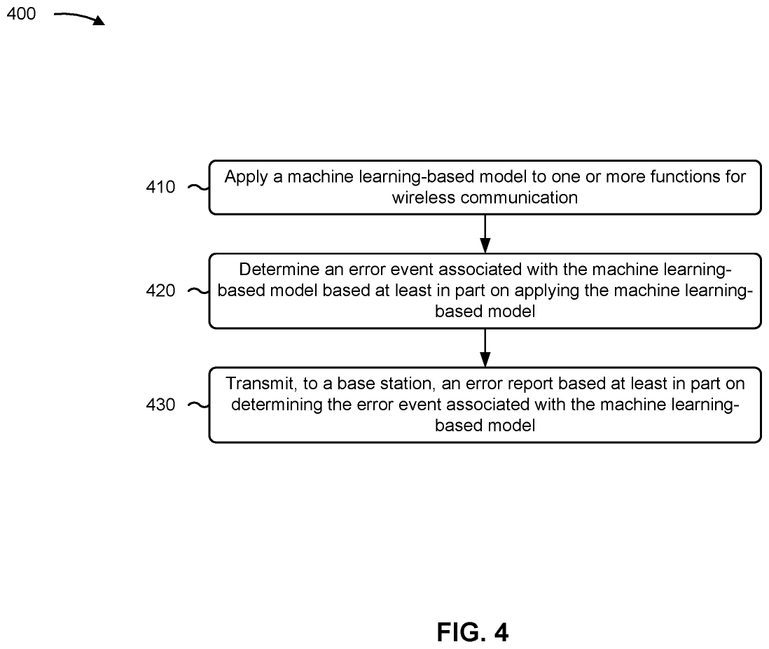

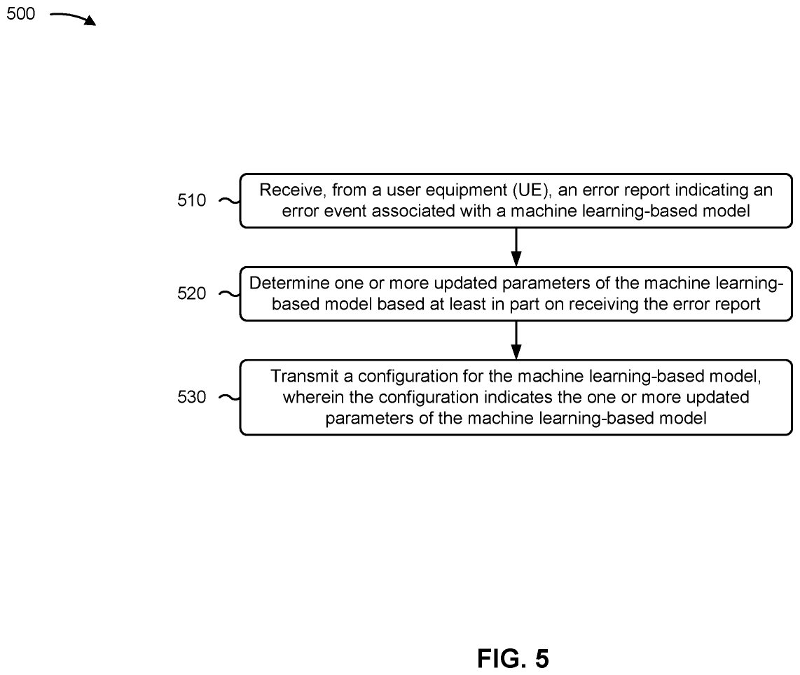

Controller/processor 240 of base station 110, controller/processor 280 of UE 120, and/or any other component(s) of FIG. 2 may perform one or more techniques associated with machine learning error reporting, as described in more detail elsewhere herein. For example, controller/processor 240 of base station 110, controller/processor 280 of UE 120, and/or any other component(s) of FIG. 2 may perform or direct operations of, for example, process 400 of FIG. 4, process 500 of FIG. 5, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 400 of FIG. 4, process 500 of FIG. 5, and/or other processes as described herein. In some aspects, executing instructions may include running the instructions, converting the instructions, compiling the instructions, and/or interpreting the instructions, among other examples.

In some aspects, UE 120 may include means for applying a machine learning-based model to one or more functions for wireless communication; means for determining an error event associated with the machine learning-based model based at least in part on applying the machine learning-based model; and/or means for transmitting, to a base station, an error report based at least in part on determining the error event associated with the machine learning-based model. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, and/or receive processor 258, among other examples.

In some aspects, base station 110 may include means for receiving, from a UE, an error report indicating an error event associated with a machine learning-based model; means for determining one or more updated parameters of the machine learning-based model based at least in part on receiving the error report; and/or means for transmitting a configuration for the machine learning-based model, wherein the configuration indicates the one or more updated parameters of the machine learning-based model. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, and/or antenna 234, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

In 5G NR, machine learning-based models may be implemented to assist cellular network performance. A machine learning-based model may include neural networks that are implemented at different types of nodes (e.g., a UE 120, a base station 110, and/or an integrated access and backhaul (IAB) node) within a wireless communication network. For example, the neural networks may be implemented at a single node or may be distributed over multiple nodes. The machine learning-based models may be implemented to assist with different functions and/or modules among the nodes of the wireless communication network. For example, the neural network may be implemented as a convolutional neural network (CNN), a recurrent neural network (RNN), a deep convolutional network (DCN), and/or the like.

At each node implemented with one or more machine learning-based models, the machine learning-based models may interact with different layers within the node. For example, the machine learning-based models may interact with one of the physical layer, the medium access control (MAC) layer or upper layers (e.g., application layers) in some instances, or with multiple layers in other instances. For example, a node may include a machine learning module adapted for low-density parity check (LDPC) decoding at the physical layer. In another example, a node may include a machine learning-based model for channel state information (CSI) prediction and/or transmission configuration indicator (TCI) selection at the physical layer and the MAC layer. In another example, a node may include a machine learning-based model for multi-user (MU) scheduling taking account for package latency and/or priority at the physical layer, the MAC layer and the upper layers. These machine learning-based models may involve various machine learning-related data transfers between different layers of different nodes. The machine learning-based models may be trained with training datasets that are produced through periodic and/or aperiodic data collection at one or more nodes. For example, measurement data collection may serve as input to the machine learning-based models. The operation of these machine learning-based models at the different nodes may be used for machine learning model parameter transfer and/or update.

In some cases, a node may include different machine learning-based models on board to predict channel properties for a future use of that channel. For example, the machine learning-based network may be implemented by a channel property prediction network to predict one or more properties of a channel. In some examples, the machine learning-based models are tasked to predict what transmission beam to use for a base station and/or reception beam to use for a UE. For example, the machine learning-based model may be implemented by a beam selection prediction network to predict the base station transmission beam and/or the UE reception beam. In some examples, the machine learning-based models are tasked to predict the delay spread of a channel. For example, the machine learning-based model may be implemented by a delay spread prediction network to predict the delay spread on a channel. In some examples, the machine learning-based models may be tasked to predict a best time or condition to hand over channel communication to another base station, and further predict as to which base station to handover. For example, the machine learning-based model may be implemented by a handover prediction network to predict a proper handover condition and/or predict a handover destination.

In various scenarios, a base station sends updates of machine learning-based models to a UE to configure the machine learning-based models, the UE may then report sampled data to the base station, and the training and updating of the machine learning-based models may occur at the base station. However, given the substantial amounts of collected sampled data that is sent back from the UE to the base station, this creates an increasingly burdensome task for the UE to report all of the sampled data and for the base station to process through the sampled data. Therefore, it is desirable for the UE to decide when to report the sampled data and which sampled data is more useful to feed back to the base station for improving the quality of the machine learning-based models. However, reporting less than all of the sampled data may result in a bias in training or updating the machine learning-based models.

Some techniques and apparatuses described herein enable a UE to report errors associated with a machine learning-based model. For example, the UE may detect an error event associated with the machine learning-based model and transmit an error report to a base station. The error report may indicate an update to one or more parameters of the machine learning-based model, may indicate one or more error predictions, and/or one or more correct predictions, among other examples. Additionally, the error report may include one or more scalar quantities used to normalize the reported predictions to a total quantity of predictions at the UE. As a result, the overhead associated with reporting sampled data associated with an error event of a machine learning-based model is reduced. Additionally, the base station, when updating or training the machine learning-based model, is enabled to normalize a quantity of the reported data to an overall quantity of data sampled by a UE, thereby eliminating any bias associated with updating or training the machine learning-based model using subsets of the overall quantity of data sampled by a UE.

FIG. 3 is a diagram illustrating an example 300 associated with machine learning error reporting, in accordance with the present disclosure. As shown in FIG. 3, a base station 110 and a UE 120 may communicate with one another.

As shown by reference number 305, the base station 110 may transmit, to the UE 120, a configuration for a machine learning-based model to be used for one or more functions for wireless communication. The configuration may indicate one or more trained parameters of the machine learning-based model. For example, the base station 110 may transmit the configuration for the machine learning-based model after training the machine learning-based model. In some aspects, the machine learning-based model may be associated with a plurality of parameters. For example, the machine learning-based model may be a deep neural network that includes hundreds or thousands of parameters. The base station 110 may transmit the configuration for the machine learning-based model using radio resource control signaling, and/or MAC control element (MAC-CE) signaling, among other examples.

As shown by reference number 310, the UE 120 may apply the machine learning-based model for one or more functions for wireless communication. For example, the UE 120 may apply the machine learning-based model to predict future channel parameters, such as an RSRP of the channel, and/or a signal-to-interference-plus-noise ratio (SINR) of the channel, among other examples (e.g., by inputting a set of past measurements of the channel parameter as input data to the machine learning-based model). Similarly, the UE 120 may apply the machine learning-based model to predict or select a channel for communicating with the base station 110, to predict a beam pair (e.g., a base station 110 Tx beam and a UE 120 Rx beam) for communicating with the base station 110, and/or to determine to predict a proper handover condition and/or predict a handover destination, among other examples.

As shown by reference number 315, the UE 120 may determine or detect an error event associated with the machine learning-based model. For example, the UE 120 may apply the machine learning-based model for one or more functions for wireless communication and may determine an error event based at least in part on applying the machine learning-based model. In some aspects, an error event may be based at least in part on the UE 120 determining one or more error predictions made by the machine learning-based model. For example, a prediction of a channel parameter (e.g., RSRP, SINR, and/or the like) at a first time (e.g., a future time) made by the machine learning-based model may differ from a measurement, performed by the UE 120, of the channel parameter at the first time. The UE 120 may determine or detect an error event associated with the machine learning-based model based at least in part on determining that a difference between a predicted parameter of a channel at a first time and a measured parameter of the channel at the first time satisfies an error threshold. In some aspects, the UE 120 may determine or detect an error event associated with the machine learning-based model based at least in part on determining that a channel is selected by the UE based at least in part on applying the machine learning-based model and determining a failure associated with a selected channel.

In some aspects, the UE 120 may determine or detect an error event associated with the machine learning-based model based at least in part on determining that a quantity of error predictions made by the machine learning-based model over a period of time satisfies a threshold. In some aspects, the UE 120 may determine or detect an error event associated with the machine learning-based model based at least in part on determining that a cost function associated with a predicted channel parameter and a measured channel parameter satisfies a threshold.

As shown by reference number 320, the UE 120 may transmit, to the base station 110, an error report indicating the error event associated with the machine learning-based model determined by the UE 120. The error report may indicate one or more measurements (e.g., of a channel, and/or of a channel parameter) performed by the UE 120 after the UE 120 determines the error event associated with the machine learning-based model. In some aspects, the error report may indicate one or more update parameters of the machine learning-based model that are determined by the UE 120. In some aspects, the error report may indicate one or more predictions made by the machine learning-based model that are associated with the error event.

For example, the UE 120 may determine the error event associated with the machine learning-based model and may update one or more parameters of the machine learning-based model based at least in part on determining the error event. The UE 120 may determine an updated parameter of the machine learning-based model based at least in part on determining a stochastic gradient decent associated with the parameter. The stochastic gradient decent may be an average gradient associated with the parameter. In some aspects, the UE 120 may determine the stochastic gradient decent associated with the parameter according to the formula:

$$G = \frac{1}{M} {\sum }_{m} \frac{δC ( f ( {X}_{m} ) , {Y}_{m} )}{δ α} ,$$

where G is the average gradient, M is a total quantity of predictions made by the machine learning-based model, m refers to a specific prediction, of the total quantity of predictions, made by the machine learning-based model, δ is a variable associated calculating the stochastic gradient decent, C(f(Xₘ), Yₘ) is a cost function associated with a prediction (f(Xₘ)) made by the machine learning-based model and a measurement or a ground truth (Yₘ) associated with the prediction made by the UE 120, and a is the parameter of the machine learning based-model. In some aspects, the UE 120 may determine a stochastic gradient decent associated with each parameter of the machine learning-based model. In some aspects, the UE 120 may indicate the stochastic gradient decent associated with each parameter of the machine learning-based model in the error report transmitted to the UE 120.

In some aspects, the UE 120 may determine an updated parameter of the machine learning-based model based at least in part on performing, for a parameter of the one or more parameters of the machine learning-based model, a backpropagation procedure to determine the updated parameter associated with the parameter. The backpropagation procedure may be based at least in part on a stochastic gradient decent associated with the parameter. For example, the UE 120 may perform the backpropagation procedure for a parameter of the machine learning-based model using the equation: αᵤ=α−AG, where αᵤ is the updated parameter, α is the parameter (e.g., used when applying the machine learning-based model), λ is a variable associated with the backpropagation procedure, and G is the stochastic gradient decent associated with the parameter. The UE 120 may perform a similar backpropagation procedure for each parameter of the machine learning-based model to determine a set of updated parameters for the machine learning-based model. The UE 120 may indicate the set of updated parameters for the machine learning-based model in the error report transmitted to the base station 110. In some aspects, the UE 120 may determine a quantity of predictions used to determine the set of updated parameters of the machine learning-based model. The UE 120 may indicate the quantity of predictions used to determine the set of updated parameters in the error report transmitted to the base station 110.

In some aspects, the UE 120 may not determine updated parameters for the machine learning-based model. Instead, the UE 120 may determine one or more error predictions made by the machine learning-based model (e.g., associated with the error event determined by the UE 120). The UE 120 may determine one or more error predictions based at least in part on applying the machine learning-based model to one or more functions for wireless communication. As described above, an error prediction may be a prediction that differs from a measured value associated with the prediction by a threshold. For example, the UE 120 may determine a predicted parameter of a channel at a first time based at least in part on a set of input data, may determine a measurement of the parameter of the channel at the first time, and may determine that a difference between the predicted parameter of the channel and the measurement of the parameter of the channel satisfies an error threshold. The UE 120 may indicate the one or more error predictions in the error report transmitted to the base station 110. The UE 120 may indicate an error prediction, of the one or more error prediction, in the error report by indicating a set of input data associated with determining the predicted parameter of a channel at a first time, the predicted parameter of the channel at the first time, and one or more measurements of the parameter of the channel at the first time.

The UE 120 may determine a scalar quantity associated with the one or more error predictions. The scalar quantity may be based at least in part on a quantity of the one or more error predictions indicated in the error report. The scalar quantity may be a ratio of a quantity of overall predictions made by the machine learning-based model to the quantity of the one or more error predictions. For example, if the quantity of overall predictions is 100 and the quantity of the one or more error predictions is 1, the scalar quantity may be 100 (e.g., based at least in part on a ratio of 100-to-1). The quantity of overall predictions made by the machine learning-based model may be a quantity of predictions since a last error report transmitted by the UE 120. The scalar quantity may be used to normalize the quantity of the one or more error predictions to the overall quantity of predictions made by the machine learning-based model. In this way, the UE 120 may indicate a weight or scalar that should be applied when updated the one or more parameters of the machine learning-based model so that the UE 120 does not have to transmit all predictions made by the machine learning-based model. This may ensure that the base station 110, when updating the one or more parameters of the machine learning-based model, does not give too much weight to (or introduce bias associated with) the one or more error predictions.

In some aspects, the UE 120 may determine one or more correct predictions based at least in part on applying the machine learning-based model to one or more functions for wireless communication. For example, the UE 120 may determine a predicted parameter of a channel at a first time based at least in part on a set of input data, may determine a measurement of the parameter of the channel at the first time, and may determine that a difference between the predicted parameter of the channel and the measurement of the parameter of the channel does not satisfy the error threshold. The UE 120 may indicate the one or more correct predictions in the error report transmitted to the base station 110. The UE 120 may determine a scalar quantity associated with the one or more correct predictions (e.g., indicating a ratio of a quantity of the one or more correct predictions to the total predictions made by the machine learning-based model. The UE 120 may indicate the scalar quantity associated with the one or more correct predictions in the error report transmitted to the base station 110. In some aspects, the one or more correct predictions indicated in the error report may be a subset of a total quantity of correct predictions determined by the UE 120. For example, the UE 120 may determine a subset of correct predictions from a set of correct predictions, determine a scalar quantity associated with the subset of correct predictions, and indicate the subset of correct predictions and the scalar quantity associated with the subset of correct predictions in the error report transmitted to the base station 110. In this way, the UE 120 may avoid bias associated with reporting only error predictions and may reduce an overhead of the reporting by reporting only a subset of correct predictions.

In some aspects, the UE 120 may transmit the error report in one or more communications. For example, the UE 120 may transmit an error report in a first communication. The error report in the first communication may indicate the one or more error predictions and the scalar quantity associated with the one or more error predictions. The UE 120 may transmit the error report in a second communication. The error report in the second communication may indicate the one or more correct predictions and the scalar quantity associated with the one or more correct predictions. The error report in the first communication may include an indicator indicating that the predictions included in the error report are error predictions. Similarly, the error report in the second communication may include an indicator indicating that the predictions included in the error report are correct predictions. In this way, the base station 110 may differentiate between error predictions and correct predictions indicated in the error report.

In some aspects, information to be included in the error report may be configured by the base station 110. For example, the base station 110 may transmit, to the UE 120, a configuration indicating the information to be included in the error report (e.g., updated parameters, gradients, and/or predictions). The configuration may indicate whether the UE 120 is to determine updates to the parameters of the machine learning-based model. In some aspects, the UE 120 may transmit, to the base station 110, an indication of an error reporting capability of the UE 120. The UE 120 may transmit the indication of the error reporting capability of the UE 120 after an initial access period (e.g., after completing a random access procedure). The error reporting capability of the UE 120 may indicate whether the UE 120 is capable of determining updates to the parameters of the machine learning-based model. The configuration transmitted by the base station 110 may be based at least in part on the error reporting capability of the UE 120. The configuration indicating the information to be included in the error report may be included in the configuration of the machine learning-based model (e.g., described above with respect to reference number 305) or may be a separate configuration.

In some aspects, the UE 120 may transmit the error report periodically (e.g., according to a periodic schedule configured by the base station 110). For example, the UE 120 may determine, according to a periodic schedule, one or more updated parameters of the machine learning-based model based at least in part on determining the error event associated with the machine learning-based model. The UE 120 may transmit, according to the periodic schedule and to the base station 110, the error report indicating the one or more updated parameters of the machine learning-based model.

In some aspects, the UE 120 may transmit the error report based at least in part on a quantity of predictions made by the machine learning-based model since a last error report was transmitted by the UE 120. For example, the UE 120 may determine that a quantity of predictions associated with applying the machine learning-based model to one or more functions for wireless communication satisfies a reporting threshold and may transmit the error report based at least in part on determining that the quantity of predictions associated with applying the machine learning-based model satisfies the reporting threshold.

As shown by reference number 325, the base station 110 may determine one or more updated parameters of the machine learning-based model based at least in part on receiving the error report from the UE 120. For example, the error report may indicate the one or more updated parameters of the machine learning-based model (e.g., as determined by the UE 120). The base station 110 may update the one or more parameters of the machine learning-based model based at least in part on the one or more updated parameters indicated in the error report.

In some aspects, the error report may indicate one or more error predictions made by the machine learning-based model (e.g., at a machine learning module of the UE 120). The base station 110 may determine the one or more updated parameters based at least in part on the one or more error predictions indicated in the error report. For example, for a parameter of the one or more parameter of the machine learning-based model, the base station 110 may determine, a stochastic gradient decent associated with the parameter based at least in part on the one or more error predictions and the scalar quantity associated with the one or more error predictions. The base station 110 may determine the stochastic gradient decent associated with the parameter taking into account the scalar quantity to avoid bias in updating the parameter. For example, the equation used by the base station 110 to determine the stochastic gradient decent may be the equation described above, modified by the scalar quantity, such that the equation becomes:

$$G = \frac{1}{γ M e} {\sum }_{me} \frac{δC ( f ( {X}_{m e} ) , {Y}_{m e} )}{δ α} ,$$

where γ is the scalar quantity associated with the one or more error predictions, Me is the quantity of the one or more error predictions, and me refers to a specific error prediction of the one or more error predictions. The base station 110 may determine the updated parameter based at least in part on determining the stochastic gradient decent associated with the parameter. For example, the base station 110 may perform a backpropagation procedure associated with the parameter using the stochastic gradient decent associated with the parameter (e.g., determined from the one or more error predictions) in a similar manner as described above.

In some aspects, the base station 110 may determine the stochastic gradient decent associated with the parameter based at least in part on the one or more error predictions and one or more correct predictions indicated in the error report. The base station 110 may determine the stochastic gradient decent associated with the parameter based at least in part on the one or more error predictions, the scalar quantity associated with the one or more error predictions, the one or more correct predictions, and a scalar quantity associated with the one or more correct predictions. In some aspects, the base station 110 may modify the equation used to determine the stochastic gradient decent associated with the parameter to take the one or more correct predictions into account as follows:

$$G = \frac{1}{{M}^{′}} ( \frac{1}{{γ}_{1}^{′}} {\sum }_{me} \frac{δC ( f ( {X}_{m e} ) , {Y}_{m e} )}{δ α} + \frac{1}{{γ}_{2}^{′}} {\sum }_{mc} \frac{δC ( f ( {X}_{m c} ) , {Y}_{m c} )}{δ α} ) ,$$

where γ₁ is the scalar quantity associated with the one or more error predictions, γ₂ is the scalar quantity associated with the one or more correct predictions, Mc is a quantity of the one or more correct predictions, and mc refers to a specific correct prediction of the one or more correct predictions. In some aspects, the base station 110 may modify the equation used to determine the stochastic gradient decent associated with the parameter to take the one or more correct predictions into account as follows:

$$G = \frac{1}{{M}^{′}} ( \frac{1}{{γ}_{1}^{′}} {\sum }_{me} \frac{δC ( f ( {X}_{m e} ) , {Y}_{m e} )}{δ α} + \frac{1}{{γ}_{2}^{′}} {\sum }_{mc} \frac{δC ( f ( {X}_{m c} ) , {Y}_{m c} )}{δ α} ) ,$$

where M′ is a quantity of predictions indicated in the error report (e.g., one or more error predictions and/or one or more correct predictions), γ′₁ is the scalar quantity associated with the one or more error predictions (e.g., which may be the same as the scalar quantity described above or may be modified based at least in part on the quantity of predictions indicated in the error report), and γ′₂ is the scalar quantity associated with the one or more correct predictions (e.g., which may be the same as the scalar quantity described above or may be modified based at least in part on the quantity of predictions indicated in the error report).

The base station 110 may updated the one or more parameters of the machine learning-based model based at least in part on determining the stochastic gradient decent (e.g., that considers both error predictions and correct predictions) associated with the one or more parameters. In this way, the base station 110 may update the one or more parameters of the machine learning-based model to avoid bias that may be introduced if the base station 110 were to only consider error predictions, if the base station 110 were to not consider the scalar quantities.

In some aspects, the base station 110 may receive error reports from one or more other UEs in a similar manner as described above. The base station 110 may determine the one or more updated parameters of the machine learning-based model based at least in part on one or more error reports receive from the one or more other UEs in a similar manner as described above. As a result, the base station 110 may determine the one or more updated parameters of the machine learning-based model based at least in part on receiving a plurality of error reports.

As shown by reference number 330, the base station 110 may transmit, to the UE 120, an updated configuration of the machine learning-based model. The updated configuration may indicate the one or more updated parameters of the machine learning-based model. In some aspects, the base station 110 may transmit the updated configuration of the machine learning-based model using MAC-CE signaling. The UE 120 may receive the updated configuration of the machine learning-based model and may apply the machine learning-based model (e.g., using the one or more updated parameters) to one or more functions for wireless communication.

As a result, overhead associated with reporting sampled data associated with an error event of a machine learning-based model is reduced. Additionally, the base station 110, when updating or training the machine learning-based model, is enabled to normalize a quantity of the reported data to an overall quantity of data sampled by a UE, thereby eliminating any bias associated with updating or training the machine learning-based model using subsets of the overall quantity of data sampled by a UE. Moreover, reporting both error predictions and correct predictions in an error report enables the base station 110 to perform more accurate and unbiased updates to the one or more parameters of the machine learning-based model.

As indicated above, FIG. 3 is provided as an example. Other examples may differ from what is described with respect to FIG. 3.

FIG. 4 is a diagram illustrating an example process 400 performed, for example, by a UE, in accordance with the present disclosure. Example process 400 is an example where the UE (e.g., UE 120) performs operations associated with machine learning error reporting.

As shown in FIG. 4, in some aspects, process 400 may include applying a machine learning-based model to one or more functions for wireless communication (block 410). For example, the UE (e.g., using receive processor 258, transmit processor 264, controller/processor 280, memory 282, and/or the like) may apply a machine learning-based model to one or more functions for wireless communication, as described above.

As further shown in FIG. 4, in some aspects, process 400 may include determining an error event associated with the machine learning-based model based at least in part on applying the machine learning-based model (block 420). For example, the UE (e.g., using receive processor 258, transmit processor 264, controller/processor 280, memory 282, and/or the like) may determine an error event associated with the machine learning-based model based at least in part on applying the machine learning-based model, as described above.

As further shown in FIG. 4, in some aspects, process 400 may include transmitting, to a base station, an error report based at least in part on determining the error event associated with the machine learning-based model (block 430). For example, the user equipment (e.g., using receive processor 258, transmit processor 264, controller/processor 280, memory 282, and/or the like) may transmit, to a base station, an error report based at least in part on determining the error event associated with the machine learning-based model, as described above.

Process 400 may include additional aspects, such as any single aspect or any combination of aspects described below and/or in connection with one or more other processes described elsewhere herein.

In a first aspect, process 400 includes receiving, from the base station, a configuration for the machine learning-based model, wherein the configuration indicates one or more parameters associated with the machine learning-based model.

In a second aspect, alone or in combination with the first aspect, determining the error event associated with the machine learning-based model comprises determining that a difference between a predicted parameter of a channel at a first time and a measured parameter of the channel at the first time satisfies an error threshold; or determining a failure associated with a selected channel, wherein the selected channel is selected by the UE based at least in part on applying the machine learning-based model.

In a third aspect, alone or in combination with one or more of the first and second aspects, transmitting the error report comprises performing one or more measurements of a channel parameter based at least in part on determining the error event associated with the machine learning-based model, and transmitting, to the base station, the error report indicating the one or more measurements.

In a fourth aspect, alone or in combination with one or more of the first through third aspects, transmitting the error report comprises determining one or more updated parameters of the machine learning-based model based at least in part on determining the error event associated with the machine learning-based model, and transmitting, to the base station, the error report indicating the one or more updated parameters of the machine learning-based model.

In a fifth aspect, alone or in combination with one or more of the first through fourth aspects, determining one or more updated parameters of the machine learning-based model comprises determining, for a parameter of the one or more parameters, a stochastic gradient decent associated with the parameter, and updating the parameter of the one or more parameters based at least in part on determining the stochastic gradient decent associated with the parameter.

In a sixth aspect, alone or in combination with one or more of the first through fifth aspects, determining one or more updated parameters of the machine learning-based model comprises performing, for a parameter of the one or more parameters, a backpropagation procedure to determine an updated parameter associated with the parameter.

In a seventh aspect, alone or in combination with one or more of the first through sixth aspects, transmitting the error report comprises determining a quantity of predictions used to determine the one or more updated parameters of the machine learning-based model, and transmitting, to the base station, the error report indicating the quantity of predictions used to determine the one or more updated parameters of the machine learning-based model.

In an eighth aspect, alone or in combination with one or more of the first through seventh aspects, transmitting the error report comprises determining one or more error predictions based at least in part on applying the machine learning-based model to one or more functions for wireless communication; determining a scalar quantity associated with the one or more error predictions, wherein the scalar quantity is based at least in part on a quantity of the one or more error predictions; and transmitting the error report indicating the one or more error predictions and the scalar quantity associated with the one or more error predictions.

In a ninth aspect, alone or in combination with one or more of the first through eighth aspects, determining the one or more error predictions comprises determining a predicted parameter of a channel at a first time based at least in part on a set of input data; determining a measurement of the parameter of the channel at the first time, and determining that a difference between the predicted parameter of the channel and the measurement of the parameter of the channel satisfies an error threshold.

In a tenth aspect, alone or in combination with one or more of the first through ninth aspects, the error report includes a set of input data associated with determining a predicted parameter of a channel at a first time, the predicted parameter of the channel at the first time, and one or more measurements of the parameter of the channel at the first time.

In an eleventh aspect, alone or in combination with one or more of the first through tenth aspects, determining the scalar quantity associated with the one or more error predictions comprises determining a ratio of a quantity of overall predictions to the quantity of the one or more error predictions.

In a twelfth aspect, alone or in combination with one or more of the first through eleventh aspects, the quantity of overall predictions is a quantity of predictions since a last error report transmitted by the UE.

In a thirteenth aspect, alone or in combination with one or more of the first through twelfth aspects, transmitting the error report comprises determining one or more correct predictions based at least in part on applying the machine learning-based model to one or more functions for wireless communication; determining a scalar quantity associated with the one or more correct predictions, wherein the scalar quantity associated with the one or more correct predictions is based at least in part on a quantity of the one or more correct predictions, and transmitting the error report indicating the one or more correct predictions and the scalar quantity associated with the one or more correct predictions.

In a fourteenth aspect, alone or in combination with one or more of the first through thirteenth aspects, determining the one or more correct predictions comprises determining a predicted parameter of a channel at a first time based at least in part on a set of input data; determining a measurement of the parameter of the channel at the first time, and determining that a difference between the predicted parameter of the channel and the measurement of the parameter of the channel does not satisfy an error threshold.

In a fifteenth aspect, alone or in combination with one or more of the first through fourteenth aspects, the one or more correct predictions are a subset of a total quantity of correct predictions.

In a sixteenth aspect, alone or in combination with one or more of the first through fifteenth aspects, transmitting the error report comprises transmitting, in a first communication, an error report indicating one or more error predictions and a scalar quantity associated with the one or more error predictions, and transmitting, in a second communication, an error report indicating one or more correct predictions and a scalar quantity associated with the one or more correct predictions.

In a seventeenth aspect, alone or in combination with one or more of the first through sixteenth aspects, transmitting the error report comprises determining, according to a periodic schedule, one or more updated parameters of the machine learning-based model based at least in part on determining the error event associated with the machine learning-based model, and transmitting, according to the periodic schedule and to the base station, the error report indicating the one or more updated parameters of the machine learning-based model.

In an eighteenth aspect, alone or in combination with one or more of the first through seventeenth aspects, transmitting the error report comprises determining that a quantity of predictions associated with applying the machine learning-based model to one or more functions for wireless communication satisfies a reporting threshold; determining one or more updated parameters of the machine learning-based model based at least in part on the quantity of predictions, and transmitting, to the base station, the error report indicating the one or more updated parameters of the machine learning-based model.

In a nineteenth aspect, alone or in combination with one or more of the first through eighteenth aspects, process 400 includes receiving, from the base station, a configuration indicating information to be included in the error report, and transmitting, to the base station, the error report is based at least in part on the configuration indicating information to be included in the error report.

In a twentieth aspect, alone or in combination with one or more of the first through nineteenth aspects, process 400 includes transmitting, to the base station, an indication of an error reporting capability of the UE, and transmitting, to the base station, the error report is based at least in part transmitting the indication of the error reporting capability of the UE.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a base station, in accordance with the present disclosure. Example process 500 is an example where the base station (e.g., base station 110) performs operations associated with machine learning error reporting.

As shown in FIG. 5, in some aspects, process 500 may include receiving, from a UE, an error report indicating an error event associated with a machine learning-based model (block 510). For example, the base station (e.g., using transmit processor 220, receive processor 238, controller/processor 240, memory 242, and/or the like) may receive, from a UE, an error report indicating an error event associated with a machine learning-based model, as described above.

As further shown in FIG. 5, in some aspects, process 500 may include determining one or more updated parameters of the machine learning-based model based at least in part on receiving the error report (block 520). For example, the base station (e.g., using transmit processor 220, receive processor 238, controller/processor 240, memory 242, and/or the like) may determine one or more updated parameters of the machine learning-based model based at least in part on receiving the error report, as described above.

As further shown in FIG. 5, in some aspects, process 500 may include transmitting a configuration for the machine learning-based model, wherein the configuration indicates the one or more updated parameters of the machine learning-based model (block 530). For example, the base station (e.g., using transmit processor 220, receive processor 238, controller/processor 240, memory 242, and/or the like) may transmit a configuration for the machine learning-based model, wherein the configuration indicates the one or more updated parameters of the machine learning-based model.

Process 500 may include additional aspects, such as any single aspect or any combination of aspects described below and/or in connection with one or more other processes described elsewhere herein.

In a first aspect, process 500 includes transmitting, to the UE, an initial configuration for the machine learning-based model, wherein the initial configuration indicates one or more parameters associated with the machine learning-based model.

In a second aspect, alone or in combination with the first aspect, receiving the error report comprises receiving, from the UE, the error report indicating one or more measurements of a channel parameter, wherein the one or more measurements are performed after the UE determined the error event.

In a third aspect, alone or in combination with one or more of the first and second aspects, receiving the error report comprises receiving, from the UE, the error report indicating the one or more updated parameters of the machine learning-based model, wherein the one or more updated parameters are determined by the UE.

In a fourth aspect, alone or in combination with one or more of the first through third aspects, receiving the error report comprises receiving, from the UE, the error report indicating a quantity of predictions used to determine the one or more updated parameters of the machine learning-based model.

In a fifth aspect, alone or in combination with one or more of the first through fourth aspects, receiving the error report comprises receiving the error report indicating one or more error predictions of the machine learning-based model and a scalar quantity associated with the one or more error predictions.

In a sixth aspect, alone or in combination with one or more of the first through fifth aspects, the one or more error predictions indicate a set of input data associated with determining a predicted parameter of a channel at a first time, the predicted parameter of the channel at the first time, and one or more measurements of the parameter of the channel at the first time.

In a seventh aspect, alone or in combination with one or more of the first through sixth aspects, the scalar quantity associated with the one or more error predictions indicates a ratio of a quantity of overall predictions to a quantity of the one or more error predictions.

In an eighth aspect, alone or in combination with one or more of the first through seventh aspects, the quantity of overall predictions is a quantity of predictions since a last error report transmitted by the UE.

In a ninth aspect, alone or in combination with one or more of the first through eighth aspects, determining the one or more updated parameters of the machine learning-based model comprises determining, for a parameter of the one or more parameters, a stochastic gradient decent associated with the parameter based at least in part on the one or more error predictions and the scalar quantity associated with the one or more error predictions, and updating the parameter of the one or more parameters based at least in part on determining the stochastic gradient decent associated with the parameter.

In a tenth aspect, alone or in combination with one or more of the first through ninth aspects, determining the one or more updated parameters of the machine learning-based model comprises performing, for a parameter of the one or more parameters, a backpropagation procedure to determine an updated parameter associated with the parameter, wherein the backpropagation procedure is based at least in part on the one or more error predictions and the scalar quantity associated with the one or more error predictions.

In an eleventh aspect, alone or in combination with one or more of the first through tenth aspects, receiving the error report comprises receiving, from the UE, the error report indicating one or more correct predictions of the machine learning-based model and a scalar quantity associated with the one or more correct predictions.

In a twelfth aspect, alone or in combination with one or more of the first through eleventh aspects, determining the one or more updated parameters of the machine learning-based model comprises determining, for a parameter of the one or more parameters, a stochastic gradient decent associated with the parameter based at least in part on the one or more error predictions, the scalar quantity associated with the one or more error predictions, the one or more correct predictions, and the scalar quantity associated with the one or more correct predictions, and updating the parameter of the one or more parameters based at least in part on determining the stochastic gradient decent associated with the parameter.

In a thirteenth aspect, alone or in combination with one or more of the first through twelfth aspects, the one or more correct predictions are a subset of a total quantity of correct predictions.

In a fourteenth aspect, alone or in combination with one or more of the first through thirteenth aspects, receiving the error report comprises receiving, in a first communication, an error report indicating one or more error predictions of the machine learning-based model and a scalar quantity associated with the one or more error predictions, and receiving, in a second communication, an error report indicating one or more correct predictions of the machine learning-based model and a scalar quantity associated with the one or more correct predictions.

In a fifteenth aspect, alone or in combination with one or more of the first through fourteenth aspects, receiving the error report comprises receiving, according to a periodic schedule and from the UE, the error report indicating one or more updated parameters of the machine learning-based model.

In a sixteenth aspect, alone or in combination with one or more of the first through fifteenth aspects, receiving the error report comprises receiving, from the UE, the error report indicating one or more updated parameters of the machine learning-based model based at least in part on a determination that a quantity of predictions of machine learning-based model at the UE satisfies a reporting threshold.

In an seventeenth aspect, alone or in combination with one or more of the first through sixteenth aspects, process 500 includes determining information to be included in an error report from the UE; and transmitting, to the UE, a configuration indicating the information to be included in the error report, wherein receiving, from the UE, the error report is based at least in part on the configuration indicating information to be included in the error report.

In a eighteenth aspect, alone or in combination with one or more of the first through seventeenth aspects, process 500 includes receiving, from the UE, an indication of an error reporting capability of the UE, wherein receiving, from the UE, the error report is based at least in part receiving the indication of the error reporting capability of the UE.

In a nineteenth aspect, alone or in combination with one or more of the first through eighteenth aspects, receiving, from the UE, an error report indicating an error event associated with the machine learning-based model comprises receiving, from a plurality of UEs, a plurality of error reports indicating a plurality of error events associated with the machine learning-based model, and determining one or more updated parameters of the machine learning-based model is based at least in part on receiving the plurality of error reports.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

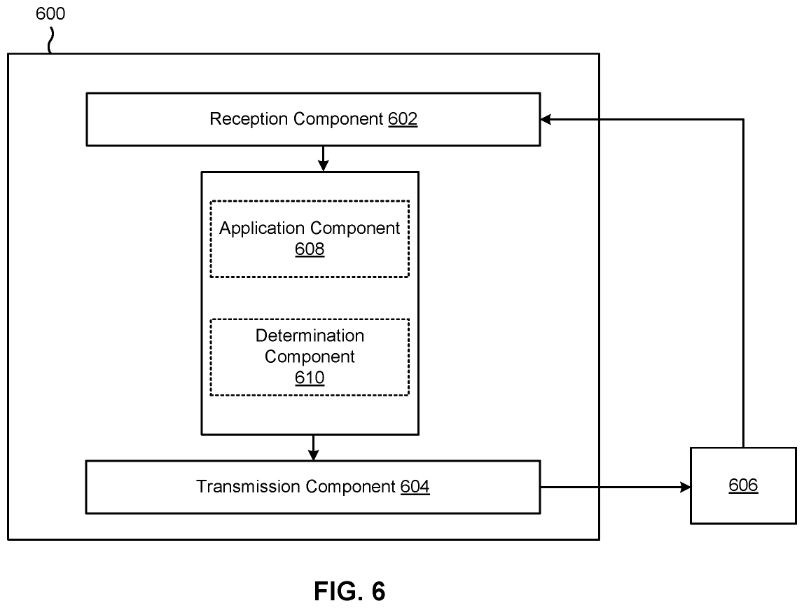

FIG. 6 is a diagram of an example apparatus 600 for wireless communication, in accordance with the present disclosure. The apparatus 600 may be a user equipment, or a user equipment may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include one or more of an application component 608 or a determination component 610, among other examples.

In some aspects, the apparatus 600 may be configured to perform one or more operations described herein in connection with FIG. 3. Additionally or alternatively, the apparatus 600 may be configured to perform one or more processes described herein, such as process 400 of FIG. 4, or a combination thereof. In some aspects, the apparatus 600 and/or one or more components shown in FIG. 6 may include one or more components of the user equipment described above in connection with FIG. 2. Additionally, or alternatively, one or more components shown in FIG. 6 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the user equipment described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the user equipment described above in connection with FIG. 2. In some aspects, the transmission component 604 may be collocated with the reception component 602 in a transceiver.

The reception component 602 may receive a configuration for a machine learning-based model. The application component 608 may apply a machine learning-based model to one or more functions for wireless communication. The determination component 610 may determine an error event associated with the machine learning-based model based at least in part on applying the machine learning-based model. The transmission component 604 may transmit an error report based at least in part on determining the error event associated with the machine learning-based model.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIG. 6.

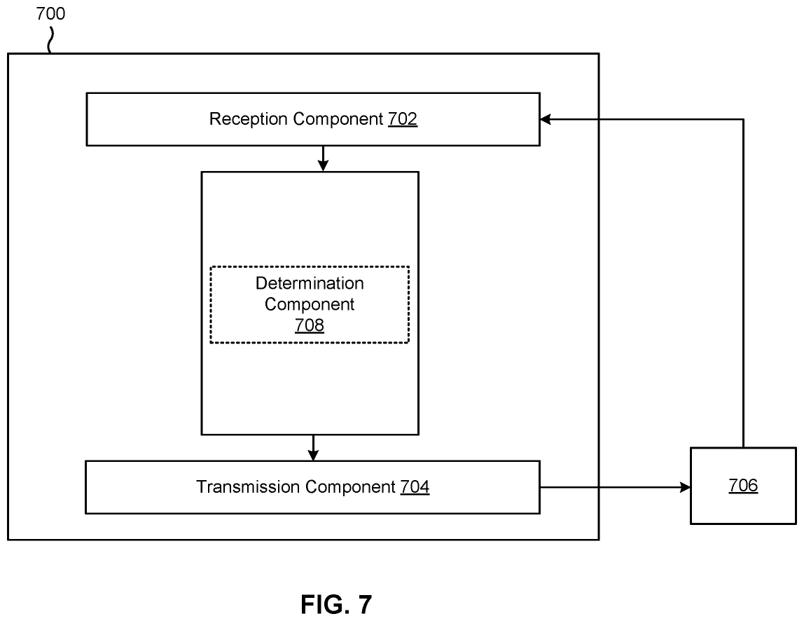

FIG. 7 is a diagram of an example apparatus 700 for wireless communication, in accordance with the present disclosure. The apparatus 700 may be a base station, or a base station may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include one or more of a determination component 708, among other examples.

In some aspects, the apparatus 700 may be configured to perform one or more operations described herein in connection with FIG. 3. Additionally or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the base station described above in connection with FIG. 2. Additionally, or alternatively, one or more components shown in FIG. 7 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the base station described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the base station described above in connection with FIG. 2. In some aspects, the transmission component 704 may be collocated with the reception component 702 in a transceiver.

The reception component 702 may receive an error report indicating an error event associated with a machine learning-based model. The determination component 708 may determine one or more updated parameters of the machine learning-based model based at least in part on receiving the error report. The transmission component 704 may transmit a configuration for the machine learning-based model that indicates the one or more updated parameters of the machine learning-based model.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: applying a machine learning-based model to one or more functions for wireless communication; determining an error event associated with the machine learning-based model based at least in part on applying the machine learning-based model; and transmitting, to a base station, an error report based at least in part on determining the error event associated with the machine learning-based model.

Aspect 2: The method of Aspect 1, further comprising: receiving, from the base station, a configuration for the machine learning-based model, wherein the configuration indicates one or more parameters associated with the machine learning-based model.

Aspect 3: The method of any of Aspects 1-2, wherein determining the error event associated with the machine learning-based model comprises: determining that a difference between a predicted parameter of a channel at a first time and a measured parameter of the channel at the first time satisfies an error threshold; or determining a failure associated with a selected channel, wherein the selected channel is selected by the UE based at least in part on applying the machine learning-based model.

Aspect 4: The method of any of Aspects 1-3, wherein transmitting the error report comprises: performing one or more measurements of a channel parameter based at least in part on determining the error event associated with the machine learning-based model; and transmitting, to the base station, the error report indicating the one or more measurements.

Aspect 5: The method of any of Aspects 1-4, wherein transmitting the error report comprises: determining one or more updated parameters of the machine learning-based model based at least in part on determining the error event associated with the machine learning-based model; and transmitting, to the base station, the error report indicating the one or more updated parameters of the machine learning-based model.

Aspect 6: The method of Aspect 5, wherein determining one or more updated parameters of the machine learning-based model comprises: determining, for a parameter of the one or more parameters, a stochastic gradient decent associated with the parameter; and updating the parameter of the one or more parameters based at least in part on determining the stochastic gradient decent associated with the parameter.

Aspect 7: The method of any of Aspects 5-6, wherein determining one or more updated parameters of the machine learning-based model comprises: performing, for a parameter of the one or more parameters, a backpropagation procedure to determine an updated parameter associated with the parameter.

Aspect 8: The method of any of Aspects 5-7, wherein transmitting the error report comprises: determining a quantity of predictions used to determine the one or more updated parameters of the machine learning-based model; and transmitting, to the base station, the error report indicating the quantity of predictions used to determine the one or more updated parameters of the machine learning-based model.

Aspect 9: The method of any of Aspects 1-8, wherein transmitting the error report comprises: determining one or more error predictions based at least in part on applying the machine learning-based model to one or more functions for wireless communication; determining a scalar quantity associated with the one or more error predictions, wherein the scalar quantity is based at least in part on a quantity of the one or more error predictions; and transmitting the error report indicating the one or more error predictions and the scalar quantity associated with the one or more error predictions.

Aspect 10: The method of Aspect 9, wherein determining the one or more error predictions comprises: determining a predicted parameter of a channel at a first time based at least in part on a set of input data; determining a measurement of the parameter of the channel at the first time; and determining that a difference between the predicted parameter of the channel and the measurement of the parameter of the channel satisfies an error threshold.

Aspect 11: The method of any of Aspects 9-10, wherein the error report includes: a set of input data associated with determining a predicted parameter of a channel at a first time; the predicted parameter of the channel at the first time; and one or more measurements of the parameter of the channel at the first time.

Aspect 12: The method of any of Aspects 9-11, wherein determining the scalar quantity associated with the one or more error predictions comprises: determining a ratio of a quantity of overall predictions to the quantity of the one or more error predictions.

Aspect 13: The method of Aspect 12, wherein the quantity of overall predictions is a quantity of predictions since a last error report transmitted by the UE.

Aspect 14: The method of any of Aspects 9-13, wherein transmitting the error report comprises: determining one or more correct predictions based at least in part on applying the machine learning-based model to one or more functions for wireless communication; determining a scalar quantity associated with the one or more correct predictions, wherein the scalar quantity associated with the one or more correct predictions is based at least in part on a quantity of the one or more correct predictions; and transmitting the error report indicating the one or more correct predictions and the scalar quantity associated with the one or more correct predictions.

Aspect 15: The method of Aspect 14, wherein determining the one or more correct predictions comprises: determining a predicted parameter of a channel at a first time based at least in part on a set of input data; determining a measurement of the parameter of the channel at the first time; and determining that a difference between the predicted parameter of the channel and the measurement of the parameter of the channel does not satisfy an error threshold.

Aspect 16: The method of any of Aspects 14-15, wherein the one or more correct predictions are a subset of a total quantity of correct predictions.

Aspect 17: The method of any of Aspects 1-16, wherein transmitting the error report comprises: transmitting, in a first communication, an error report indicating one or more error predictions and a scalar quantity associated with the one or more error predictions; and transmitting, in a second communication, an error report indicating one or more correct predictions and a scalar quantity associated with the one or more correct predictions.

Aspect 18: The method of any of Aspects 1-17, wherein transmitting the error report comprises: determining, according to a periodic schedule, one or more updated parameters of the machine learning-based model based at least in part on determining the error event associated with the machine learning-based model; and transmitting, according to the periodic schedule and to the base station, the error report indicating the one or more updated parameters of the machine learning-based model.

Aspect 19: The method of any of Aspects 1-18, wherein transmitting the error report comprises: determining that a quantity of predictions associated with applying the machine learning-based model to one or more functions for wireless communication satisfies a reporting threshold; determining one or more updated parameters of the machine learning-based model based at least in part on the quantity of predictions; and transmitting, to the base station, the error report indicating the one or more updated parameters of the machine learning-based model.

Aspect 20: The method of any of Aspects 1-19, further comprising: receiving, from the base station, a configuration indicating information to be included in the error report, wherein transmitting, to the base station, the error report is based at least in part on the configuration indicating information to be included in the error report.

Aspect 21: The method of any of Aspects 1-20, further comprising: transmitting, to the base station, an indication of an error reporting capability of the UE, wherein transmitting, to the base station, the error report is based at least in part transmitting the indication of the error reporting capability of the UE.

Aspect 22: A method of wireless communication performed by a base station, comprising: receiving, from a user equipment (UE), an error report indicating an error event associated with a machine learning-based model; determining one or more updated parameters of the machine learning-based model based at least in part on receiving the error report; and transmitting a configuration for the machine learning-based model, wherein the configuration indicates the one or more updated parameters of the machine learning-based model.

Aspect 23: The method of Aspect 22, further comprising: transmitting, to the UE, an initial configuration for the machine learning-based model, wherein the initial configuration indicates one or more parameters associated with the machine learning-based model.

Aspect 24: The method of any of Aspects 22-23, wherein receiving the error report comprises: receiving, from the UE, the error report indicating one or more measurements of a channel parameter, wherein the one or more measurements are performed after the UE determined the error event.

Aspect 25: The method of any of Aspects 22-24, wherein receiving the error report comprises: receiving, from the UE, the error report indicating the one or more updated parameters of the machine learning-based model, wherein the one or more updated parameters are determined by the UE.

Aspect 26: The method of Aspect 25, wherein receiving the error report comprises: receiving, from the UE, the error report indicating a quantity of predictions used to determine the one or more updated parameters of the machine learning-based model.

Aspect 27: The method of any of Aspects 22-26, wherein receiving the error report comprises: receiving the error report indicating one or more error predictions of the machine learning-based model and a scalar quantity associated with the one or more error predictions.

Aspect 28: The method of Aspect 27, wherein the one or more error predictions indicate: a set of input data associated with determining a predicted parameter of a channel at a first time; the predicted parameter of the channel at the first time; and one or more measurements of the parameter of the channel at the first time.

Aspect 29: The method of any of Aspects 27-28, wherein the scalar quantity associated with the one or more error predictions indicates a ratio of a quantity of overall predictions to a quantity of the one or more error predictions.

Aspect 30: The method of Aspect 29, wherein the quantity of overall predictions is a quantity of predictions since a last error report transmitted by the UE.

Aspect 31: The method of any of Aspects 27-30, wherein determining the one or more updated parameters of the machine learning-based model comprises: determining, for a parameter of the one or more parameters, a stochastic gradient decent associated with the parameter based at least in part on the one or more error predictions and the scalar quantity associated with the one or more error predictions; and updating the parameter of the one or more parameters based at least in part on determining the stochastic gradient decent associated with the parameter.

Aspect 32: The method of any of Aspects 27-31, wherein determining the one or more updated parameters of the machine learning-based model comprises: performing, for a parameter of the one or more parameters, a backpropagation procedure to determine an updated parameter associated with the parameter, wherein the backpropagation procedure is based at least in part on the one or more error predictions and the scalar quantity associated with the one or more error predictions.

Aspect 33: The method of any of Aspects 27-32, wherein receiving the error report comprises: receiving, from the UE, the error report indicating one or more correct predictions of the machine learning-based model and a scalar quantity associated with the one or more correct predictions.

Aspect 34: The method of Aspect 33, wherein determining the one or more updated parameters of the machine learning-based model comprises: determining, for a parameter of the one or more parameters, a stochastic gradient decent associated with the parameter based at least in part on: the one or more error predictions, the scalar quantity associated with the one or more error predictions, the one or more correct predictions, and the scalar quantity associated with the one or more correct predictions; and updating the parameter of the one or more parameters based at least in part on determining the stochastic gradient decent associated with the parameter.

Aspect 35: The method of any of Aspects 33-34, wherein the one or more correct predictions are a subset of a total quantity of correct predictions.

Aspect 36: The method of any of Aspects 22-35, wherein receiving the error report comprises: receiving, in a first communication, an error report indicating one or more error predictions of the machine learning-based model and a scalar quantity associated with the one or more error predictions; and receiving, in a second communication, an error report indicating one or more correct predictions of the machine learning-based model and a scalar quantity associated with the one or more correct predictions.

Aspect 37: The method of any of Aspects 22-36, wherein receiving the error report comprises: receiving, according to a periodic schedule and from the UE, the error report indicating one or more updated parameters of the machine learning-based model.

Aspect 38: The method of any of Aspects 22-37, wherein receiving the error report comprises: receiving, from the UE, the error report indicating one or more updated parameters of the machine learning-based model based at least in part on a determination, by the UE, that a quantity of predictions of machine learning-based model at the UE satisfies a reporting threshold.

Aspect 39: The method of any of Aspects 22-38, further comprising: determining information to be included in an error report from the UE; and transmitting, to the UE, a configuration indicating the information to be included in the error report, wherein receiving, from the UE, the error report is based at least in part on the configuration indicating information to be included in the error report.

Aspect 40: The method of any of Aspects 22-39, further comprising: receiving, from the UE, an indication of an error reporting capability of the UE, wherein receiving, from the UE, the error report is based at least in part receiving the indication of the error reporting capability of the UE.

Aspect 41: The method of any of Aspects 22-40, wherein receiving, from the UE, an error report indicating an error event associated with the machine learning-based model comprises: receiving, from a plurality of UEs, a plurality of error reports indicating a plurality of error events associated with the machine learning-based model; and wherein determining one or more updated parameters of the machine learning-based model is based at least in part on receiving the plurality of error reports.

Aspect 42: An apparatus for wireless communication at a device, comprising a processor; memory coupled with the processor; and instructions stored in the memory and executable by the processor to cause the apparatus to perform the method of one or more of Aspects 1-21.

Aspect 43: A device for wireless communication, comprising a memory and one or more processors coupled to the memory, the one or more processors configured to perform the method of one or more of Aspects 1-21.

Aspect 44: An apparatus for wireless communication, comprising at least one means for performing the method of one or more of Aspects 1-21.

Aspect 45: A non-transitory computer-readable medium storing code for wireless communication, the code comprising instructions executable by a processor to perform the method of one or more of Aspects 1-21.

Aspect 46: A non-transitory computer-readable medium storing a set of instructions for wireless communication, the set of instructions comprising one or more instructions that, when executed by one or more processors of a device, cause the device to perform the method of one or more of Aspects 1-21.

Aspect 47: An apparatus for wireless communication at a device, comprising a processor; memory coupled with the processor; and instructions stored in the memory and executable by the processor to cause the apparatus to perform the method of one or more of Aspects 22-41.

Aspect 48: A device for wireless communication, comprising a memory and one or more processors coupled to the memory, the one or more processors configured to perform the method of one or more of Aspects 22-41.

Aspect 49: An apparatus for wireless communication, comprising at least one means for performing the method of one or more of Aspects 22-41.

Aspect 50: A non-transitory computer-readable medium storing code for wireless communication, the code comprising instructions executable by a processor to perform the method of one or more of Aspects 22-41.

Aspect 51: A non-transitory computer-readable medium storing a set of instructions for wireless communication, the set of instructions comprising one or more instructions that, when executed by one or more processors of a device, cause the device to perform the method of one or more of Aspects 22-41.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
apply a machine learning-based model to one or more functions for wireless communication;
determine an error event associated with the machine learning-based model based at least in part on applying the machine learning-based model; and
transmit, to a base station, an error report based at least in part on determining the error event associated with the machine learning-based model.

2. The UE of claim 1, wherein the one or more processors are further configured to:
receive, from the base station, a configuration for the machine learning-based model, wherein the configuration indicates one or more parameters associated with the machine learning-based model.

3. The UE of claim 1, wherein the one or more processors, to determine the error event associated with the machine learning-based model, are configured to:
determine that a difference between a predicted parameter of a channel at a first time and a measured parameter of the channel at the first time satisfies an error threshold; or
determine a failure associated with a selected channel, wherein the selected channel is selected by the UE based at least in part on applying the machine learning-based model.

4. The UE of claim 1, wherein the one or more processors, to transmit the error report, are configured to:
perform one or more measurements of a channel parameter based at least in part on determining the error event associated with the machine learning-based model; and
transmit, to the base station, the error report indicating the one or more measurements.

5. The UE of claim 1, wherein the one or more processors, to transmit the error report, are configured to:
determine one or more updated parameters of the machine learning-based model based at least in part on determining the error event associated with the machine learning-based model; and
transmit, to the base station, the error report indicating the one or more updated parameters of the machine learning-based model.

6. The UE of claim 5, wherein the one or more processors, to transmit the error report, are configured to:
determine a quantity of predictions used to determine the one or more updated parameters of the machine learning-based model; and
transmit, to the base station, the error report indicating the quantity of predictions used to determine the one or more updated parameters of the machine learning-based model.

7. The UE of claim 1, wherein the one or more processors, to transmit the error report, are configured to:
determine one or more error predictions based at least in part on applying the machine learning-based model to one or more functions for wireless communication;
determine a scalar quantity associated with the one or more error predictions, wherein the scalar quantity is based at least in part on a quantity of the one or more error predictions; and
transmit the error report indicating the one or more error predictions and the scalar quantity associated with the one or more error predictions.

8. The UE of claim 7, wherein the error report includes:
a set of input data associated with determining a predicted parameter of a channel at a first time;
the predicted parameter of the channel at the first time; and
one or more measurements of the parameter of the channel at the first time.

9. The UE of claim 7, wherein the one or more processors, to transmit the error report, are configured to:
determine one or more correct predictions based at least in part on applying the machine learning-based model to one or more functions for wireless communication;
determine a scalar quantity associated with the one or more correct predictions, wherein the scalar quantity associated with the one or more correct predictions is based at least in part on a quantity of the one or more correct predictions; and
transmit the error report indicating the one or more correct predictions and the scalar quantity associated with the one or more correct predictions.

10. The UE of claim 1, wherein the one or more processors, to transmit the error report, are configured to:
transmit, in a first communication, an error report indicating one or more error predictions and a scalar quantity associated with the one or more error predictions; and
transmit, in a second communication, an error report indicating one or more correct predictions and a scalar quantity associated with the one or more correct predictions.

11. The UE of claim 1, wherein the one or more processors, to transmit the error report, are configured to:
determine, according to a periodic schedule, one or more updated parameters of the machine learning-based model based at least in part on determining the error event associated with the machine learning-based model; and
transmit, according to the periodic schedule and to the base station, the error report indicating the one or more updated parameters of the machine learning-based model.

12. The UE of claim 1, wherein the one or more processors, to transmit the error report, are configured to:
determine that a quantity of predictions associated with applying the machine learning-based model to one or more functions for wireless communication satisfies a reporting threshold;
determine one or more updated parameters of the machine learning-based model based at least in part on the quantity of predictions; and
transmit, to the base station, the error report indicating the one or more updated parameters of the machine learning-based model.

13. The UE of claim 1, wherein the one or more processors are further configured to:
receive, from the base station, a configuration indicating information to be included in the error report,
wherein transmitting, to the base station, the error report is based at least in part on the configuration indicating information to be included in the error report.

14. The UE of claim 1, wherein the one or more processors are further configured to:
transmit, to the base station, an indication of an error reporting capability of the UE,
wherein transmitting, to the base station, the error report is based at least in part transmitting the indication of the error reporting capability of the UE.

15. A method of wireless communication performed by a user equipment (UE), comprising:
applying a machine learning-based model to one or more functions for wireless communication;
determining an error event associated with the machine learning-based model based at least in part on applying the machine learning-based model; and
transmitting, to a base station, an error report based at least in part on determining the error event associated with the machine learning-based model.

16. The method of claim 15, further comprising:
receiving, from the base station, a configuration for the machine learning-based model, wherein the configuration indicates one or more parameters associated with the machine learning-based model.

17. The method of claim 15, wherein determining the error event associated with the machine learning-based model comprises:
determining that a difference between a predicted parameter of a channel at a first time and a measured parameter of the channel at the first time satisfies an error threshold; or
determining a failure associated with a selected channel, wherein the selected channel is selected by the UE based at least in part on applying the machine learning-based model.

18. The method of claim 15, wherein transmitting the error report comprises:
performing one or more measurements of a channel parameter based at least in part on determining the error event associated with the machine learning-based model; and
transmitting, to the base station, the error report indicating the one or more measurements.

19. The method of claim 15, wherein transmitting the error report comprises:
determining one or more updated parameters of the machine learning-based model based at least in part on determining the error event associated with the machine learning-based model; and
transmitting, to the base station, the error report indicating the one or more updated parameters of the machine learning-based model.

20. The method of claim 19, wherein transmitting the error report comprises:
determining a quantity of predictions used to determine the one or more updated parameters of the machine learning-based model; and
transmitting, to the base station, the error report indicating the quantity of predictions used to determine the one or more updated parameters of the machine learning-based model.

21. The method of claim 15, wherein transmitting the error report comprises:
determining one or more error predictions based at least in part on applying the machine learning-based model to one or more functions for wireless communication;
determining a scalar quantity associated with the one or more error predictions, wherein the scalar quantity is based at least in part on a quantity of the one or more error predictions; and
transmitting the error report indicating the one or more error predictions and the scalar quantity associated with the one or more error predictions.

22. The method of claim 21, wherein the error report includes:
a set of input data associated with determining a predicted parameter of a channel at a first time;
the predicted parameter of the channel at the first time; and
one or more measurements of the parameter of the channel at the first time.

23. The method of claim 21, wherein transmitting the error report comprises:
determining one or more correct predictions based at least in part on applying the machine learning-based model to one or more functions for wireless communication;
determining a scalar quantity associated with the one or more correct predictions, wherein the scalar quantity associated with the one or more correct predictions is based at least in part on a quantity of the one or more correct predictions; and
transmitting the error report indicating the one or more correct predictions and the scalar quantity associated with the one or more correct predictions.

24. The method of claim 15, wherein transmitting the error report comprises:
transmitting, in a first communication, an error report indicating one or more error predictions and a scalar quantity associated with the one or more error predictions; and
transmitting, in a second communication, an error report indicating one or more correct predictions and a scalar quantity associated with the one or more correct predictions.

25. The method of claim 15, wherein transmitting the error report comprises:
determining, according to a periodic schedule, one or more updated parameters of the machine learning-based model based at least in part on determining the error event associated with the machine learning-based model; and
transmitting, according to the periodic schedule and to the base station, the error report indicating the one or more updated parameters of the machine learning-based model.

26. The method of claim 15, wherein transmitting the error report comprises:
determining that a quantity of predictions associated with applying the machine learning-based model to one or more functions for wireless communication satisfies a reporting threshold;
determining one or more updated parameters of the machine learning-based model based at least in part on the quantity of predictions; and
transmitting, to the base station, the error report indicating the one or more updated parameters of the machine learning-based model.

27. The method of claim 15, further comprising:
receiving, from the base station, a configuration indicating information to be included in the error report,
wherein transmitting, to the base station, the error report is based at least in part on the configuration indicating information to be included in the error report.

28. The method of claim 15, further comprising:
transmitting, to the base station, an indication of an error reporting capability of the UE,
wherein transmitting, to the base station, the error report is based at least in part transmitting the indication of the error reporting capability of the UE.

29. A non-transitory computer-readable medium storing one or more instructions for wireless communication, the one or more instructions comprising:
one or more instructions that, when executed by one or more processors of a user equipment, cause the one or more processors to:
apply a machine learning-based model to one or more functions for wireless communication;
determine an error event associated with the machine learning-based model based at least in part on applying the machine learning-based model; and
transmit, to a base station, an error report based at least in part on determining the error event associated with the machine learning-based model.

30. An apparatus for wireless communication, comprising:
means for applying a machine learning-based model to one or more functions for wireless communication;
means for determining an error event associated with the machine learning-based model based at least in part on applying the machine learning-based model; and
means for transmitting, to a base station, an error report based at least in part on determining the error event associated with the machine learning-based model.
